(19) United States
(12) Patent Application Publication
(10) Pub. No.: US 2004/0193770 A1
(43) Pub. Date: Sep. 30, 2004

(54) Communicating information in a computer system

(76) Inventors: Jason W. Whiteman, Spring, TX (US); Sajid A. Momin, Houston, TX (US)

Correspondence Address: HEWLETT-PACKARD COMPANY, Intellectual Property Administration, P.O. Box 272400, Fort Collins, CO, 80527-2400, US

(21) Appl. No.: 10/636,171

(22) Filed: Aug. 7, 2003

Related U.S. Application Data
(60) Provisional application No. 60/454,480, filed on Mar. 13, 2003.

(51) Int. Cl. G06F 13/14; G06F 12/00

(52) U.S. Cl. 710/305; 711/100

(57) ABSTRACT

Various exemplary embodiments are disclosed for communicating information in a computer system. In at least some embodiments, a computer system may include: a storage controller, a storage device coupled via a primary bus to the storage controller, a backplane controller coupled via a secondary bus to the storage controller, a status indicator responsive to information received from the backplane controller to indicate the status of the storage device, where the received information indicates the status of the storage device, and where the information conveyed to the status indicator is conveyed via the secondary bus.

This application claims the benefit of U.S. Provisional Application No. 60/454,480, filed Mar. 13, 2003.

### BACKGROUND

Recent trends in server technology include servers that may be contained in an enclosure, where the enclosure may be mounted in a rack. The servers may include various hardware devices including data storage devices. Thus, the amount of data storage space available to the server may be increased or decreased by adding or removing storage devices. The storage devices may be coupled to a common bus that exists on a backplane, where the bus includes a backplane controller. In this manner, the individual storage devices may operate as a larger array of storage devices where the backplane controller coordinates storing and retrieving information from the storage devices. When multiple storage devices exist within a server, it may be desirable to segment the storage space by dividing the bus into sub-busses. Dividing the communications channel may require separate backplane controllers for each sub-channel.

### BRIEF SUMMARY

Various exemplary embodiments are disclosed for communicating information in a computer system. In at least some embodiments, a computer system may include: a storage controller, a storage device coupled via a primary bus to the storage controller, a backplane controller coupled via a secondary bus to the storage controller, a status indicator responsive to status information received from the backplane controller and where the information conveyed to the status indicator is conveyed via the secondary bus.

### BRIEF DESCRIPTION OF THE DRAWINGS

For a detailed description of embodiments of the invention, reference will now be made to the accompanying drawings in which:

FIG. 1 shows a rack according to various embodiments;

FIG. 2 shows a storage device according to various embodiments;

FIG. 3A shows an implementation of a storage controller and a backplane controller according to various embodiments;

FIG. 3B shows an implementation of the secondary bus according to various embodiments;

FIG. 3C shows an alternate implementation according to various embodiments;

FIG. 4A shows a method for inserting a new device into the system according to various embodiments; and

FIG. 4B shows a method for determining storage device failure according to various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections.

The term “master device” is intended to refer to a device that can initiate a data transfer in the bus. The term “slave device” is intended to refer to a device that can be addressed by the master device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

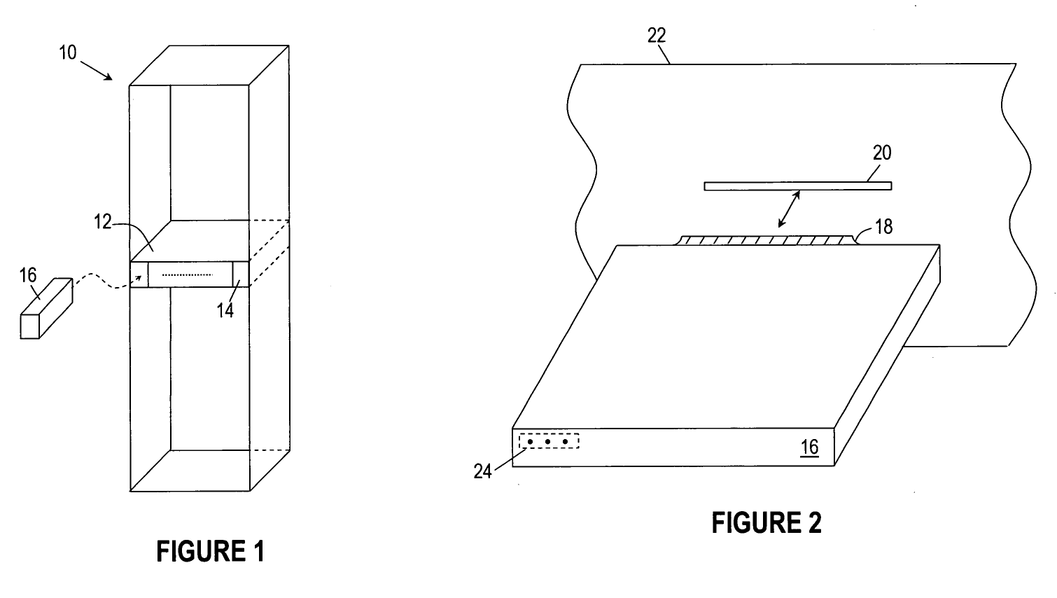

Referring now to FIG. 1, a rack or support structure 10 is shown. In general, the support structure 10 may house any structure that is capable of accommodating one or more chassis 12. An exemplary chassis 12 is shown in FIG. 1 containing one or more configurable components 14 and 16 that are capable of being physically rearranged in the chassis 12. In addition, the configurable components 14 and 16 may be configured such that they perform a variety of functions. For example, in some embodiments, configurable components 14 and 16 may be configured as storage devices (e.g., hard disk, floppy disk, CD-ROM), but in other embodiments, they may be configured as switches, routers, or power supplies. Also, the configurable components may comprise entire servers, such as blade-type servers. As shown in FIG. 1, the storage device 16 may permit easy removal and insertion into a corresponding slot of the chassis 12. Accordingly, as storage devices may be inserted and removed from the chassis 12, a modular server may be built that is capable of adaptively meeting demand. Additionally, the rack 10 may include multiple chassis 12, which may further allow the overall capability of the system to be scaled to meet demand.

FIG. 2 shows a possible implementation of the storage device 16. As shown, the device may include electrical connector pins 18. The pins 18 preferably seat into a mating electrical connector 20 on a circuit board backplane 22, thereby allowing the device to be inserted into and removed from the backplane 22 as indicated by the double headed arrow. Backplane 22 may reside in the chassis 12 and the configurable components 14 and 16 may be inserted or removed from the backplane 22 during normal system operation. Inserting and/or removing the device during normal system operation is termed “hot swapping”. Hot swapping may be advantageous in that the entire system does not need to be rebooted in order to recognize when devices are added to and removed from the system.

Other storage devices (not specifically shown in FIG. 2) also may electrically and mechanically couple to the backplane 22 and may communicate via a common bus routed through the backplane 22, such as a small computer system interconnect (“SCSI”) bus. With multiple storage devices coupled to each other, a redundant array of independent disks (“RAID”) may be formed. In general, RAID may allow accessing the storage devices in the array as if the array were one large drive. Using RAID techniques, data may be stored on the multiple storage devices so that the risks associated with device failure may be reduced and the time for accessing data also may be reduced.

Storage device 16 may also include status indicators, such as light emitting diodes (“LEDs”) 24. Alternatively, status information may be conveyed audibly, for example by using speaker 25. Although FIG. 2 shows the LEDs on the face of the storage device 16, the LEDs 24 may be integrated at any suitable location on the storage device 16 or on the chassis 12. Using the LEDs 24, information may be conveyed to a user about the status of the system and/or the status of an individual storage device, regardless of the physical location of the LEDs 24. For example, the LEDs 24 may indicate device failure, and consequently the user may need to hot swap the device. Because information may be coordinated among the various storage devices in the system, a storage controller may be used.

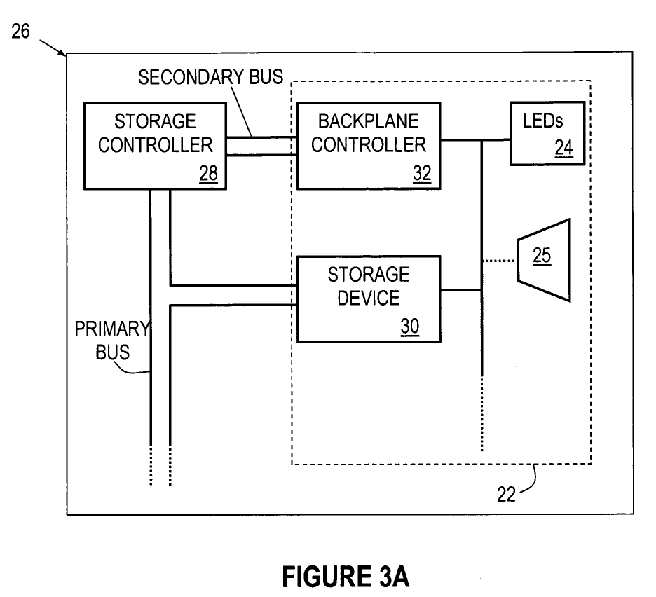

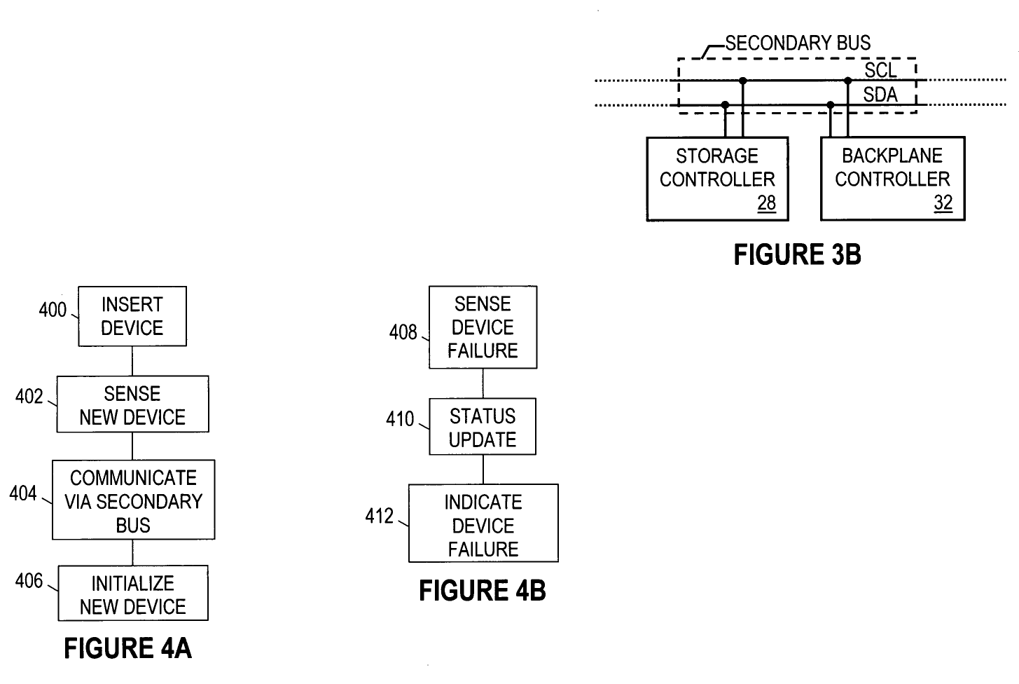

FIG. 3A shows an exemplary block diagram of a computer system 26 including a storage controller 28. Storage controller 28 is shown coupled to a storage device 30 via a primary bus. The primary bus may be any type of bus that facilitates the flow of data—e.g., SCSI, serial or parallel advanced technology attachment (“ATA”). Although not specifically shown in FIG. 3, multiple storage devices may be coupled to the primary bus. For example, multiple storage devices may be implemented to form a RAID system, where each storage device is capable of being controlled by storage controller 28 via the primary bus.

Referring still to FIG. 3A, the storage controller 28 also may couple to a backplane controller 32 through a secondary bus having substantially fewer wires than the primary bus. The secondary bus may be any type of bi-directional bus that is capable of communicating data. In some embodiments, the secondary bus may comprise an I²C bus as is disclosed in The I²C Bus Specification Ver. 2.1, January 2000 by Philips Semiconductor, which is incorporated herein by reference. The secondary bus may include two wires, including a serial data (“SDA”) line and a serial clock (“SCL”) line as shown in FIG. 3B, where both the SDA and the SCL lines are bi-directional lines. As indicated by the dotted lines in FIG. 3B, multiple devices may be coupled to the secondary bus. For example, additional backplanes, akin to backplane 22, may be coupled to the secondary bus and therefore additional controllers akin to backplane controller 32 may also couple to the secondary bus. Each device coupled to the secondary bus may have a unique address on the bus and may act as a transmitter or receiver. Devices coupled to the secondary bus may also act as master devices or slave devices, so that any device may address any other device on the secondary bus.

The storage controller 28 may obtain status information about the storage device 30 and the backplane 22 using the secondary bus. Additionally, LEDs 24 associated with each storage device may be controlled in response to information obtained by the storage controller 28. Information may be conveyed between the storage controller 28 and the backplane controller 32 regarding the operation of the LEDs 24. As the backplane controller 32 receives information from the storage controller 28, the backplane controller 32 may interpret this information and control the LEDs 24. For example, if the storage controller 28 receives information (e.g., via the primary bus) that a storage device has failed, then the storage controller 28 may issue commands to the backplane controller 32 via the secondary bus. Upon receiving the commands, the backplane controller 32 may indicate the particular storage device failure by illuminating the appropriate LEDs 24, or alternately using an audible speaker 25. The backplane controller 32 may execute code for controlling each individual LED by varying the frequency and duty cycle of the signal provided to the LED. For example, a signal at 2 Hz and 50% duty cycle may indicate normal device operation, while a signal at 1 Hz and 25% duty cycle may indicate an error condition. Other methods of indicating status are also possible.

FIG. 4A illustrates an exemplary procedure for inserting a storage device during normal system operation. Block 400 indicates insertion of a new device. As the new device is inserted into the computer system 26 (shown in FIG. 3A), the newly inserted device may couple to the storage controller 28 via the primary bus and also couple to the backplane controller 32 through backplane connections. The backplane controller 32 may maintain an internal device map of the drives in the computer system 26. As the backplane controller 32 senses the insertion of a new device, it may update its internal device map, as shown in block 402. Changes to the internal device map of the backplane controller 32 may be conveyed to the storage controller 28 via the secondary bus, as indicated by block 404. For example, backplane controller 32 (operating as the master device) may address storage controller 28 (operating as the slave device), send a device map update to the storage controller 28 via the secondary bus, and then terminate the data transfer.

The newly inserted device may be initialized by the storage controller 28 and may begin communicating data to the device via the primary bus, as indicated in block 406. Thus, as new devices are hot-swapped into the computer system 26, the primary bus may be used for data communication and initialization while the secondary bus may be used for conveying status information about the device insertion.

Referring to FIG. 4B, an exemplary procedure for determining storage device failure is shown. Block 408 illustrates sensing storage device failure and conveying that information to the storage controller 28 via the primary bus. The storage controller 28 then may issue a status update command to the backplane controller 32 over the primary bus as shown in block 410. The primary bus may be a network such as Ethernet. In this case, the storage controller 28 may control the transaction by operating as the master device while the backplane controller 32 may be operating as the slave device. Upon receiving the command from the storage controller 28, the backplane controller 32 may indicate device failure as indicated in block 412. For example, one method of indicating device failure may be by illuminating the LEDs 24 associated with the failed device. Alternatively, audible indication may be employed, for example by generating a desired tone with a speaker. Therefore, the primary bus may communicate storage device failure information while the secondary bus may be used to indicate device failure to the user.

The above discussion is meant to be illustrative of the principles and various embodiments of the present invention. Numerous variations and modifications will become apparent to those skilled in the art once the above disclosure is fully appreciated. For example, other standards may be employed to implement the secondary bus which allow a reduction in the amount of physical space used. It is intended that the following claims be interpreted to embrace all such variations and modifications.

What is claimed is:

1. A computer system, comprising:
a storage controller;
a storage device coupled via a primary bus to the storage controller;
a backplane controller coupled via a secondary bus to the storage controller;
a status indicator responsive to information received from the backplane controller to indicate the status of the storage device; and
wherein the information conveyed to the status indicator is conveyed via the secondary bus.

2. The computer system of claim 1, wherein the information conveyed to the status indicator is not conveyed via the primary bus.

3. The computer system of claim 1, wherein the status indicator includes a light indicating device.

4. The computer system of claim 1, wherein the status indicator includes an audible indicator.

5. The computer system of claim 1, wherein the primary bus is a small computer system interconnect (“SCSI”) bus.

6. The computer system of claim 3, wherein the secondary bus is an I²C bus.

7. The computer system of claim 1, wherein the secondary bus has substantially fewer lines that the primary bus.

8. The computer system of claim 6, wherein the status indicator is operable at different frequencies and each frequency relates to a different status condition of the storage device.

9. The computer system of claim 6, wherein the status information indicates storage device failure.

10. The computer system of claim 1, wherein the computer system is rack mounted and the storage device is capable of being hot swapped.

11. The computer system of claim 1, wherein the storage device comprises a blade server.

12. A method, comprising:
detecting a change in a storage device status via a primary bus, wherein the storage device communicates with a storage controller;
indicating storage device status via a secondary bus, wherein the storage controller communicates with a backplane controller; and
enabling status indicators to reflect the status of the storage device, wherein the backplane controller communicates with the status indicators via the secondary bus.

13. The method of claim 11, wherein the change in status is an insertion of a new storage device.

14. The method of claim 11, wherein the change in status is the failure of a storage device.

15. The method of claim 11, wherein the primary bus is chosen from a group consisting of a SCSI bus or an advanced technology attachment (“ATA”) bus.

16. The method of claim 12, wherein the secondary bus comprises an I²C bus.

17. The method of claim 11, wherein the secondary bus comprises substantially fewer lines that the primary bus.

18. The method of claim 14, wherein the status indicator is chosen from a group consisting of an audible indicator and an light indicating device.

19. A computer system, comprising:
a storing means for storing information;
a first controlling means for controlling the storing means, wherein the storing means and the first controlling means are coupled via a primary bus;
a secondary controlling means coupled via a secondary bus to the first controlling means;
a status indicating means that receives status information from the secondary controlling means, wherein the received information indicates the status of storage means; and
wherein the information conveyed to the status indicating means is conveyed via the secondary bus.

20. The computer system of claim 16, wherein the secondary bus comprises fewer lines that the primary bus.

21. The computer system of claim 16, wherein the status indication means indicates that the storing means has been inserted into the system.

22. The computer system of claim 16, wherein the status indication means indicates failure of the storing means.
